(19) United States
(12) Patent Application Publication
(10) Pub. No.: US 2007/0227771 A1
(43) Pub. Date: Oct. 4, 2007

(54) Gasket made of an elastomer, especially silicone

(76) Inventor: Franz Sterner, Pilgramstrasse (AT)

Correspondence Address: WILLIAM COLLARD;COLLARD & ROE, P.C., 1077 NORTHERN BOULEVARD, ROSLYN, NY, 11576, US

(21) Appl. No.: 11/728,986

(22) Filed: Mar. 27, 2007

(30) Foreign Application Priority Data
Mar. 29, 2006 (AU) A 530 / 2006

(51) Int. Cl. H02G 3/18

(52) U.S. Cl. 174/650

(57) ABSTRACT

In the case of a gasket made of an elastomer, especially silicone, for leading through several single-conductor cables (7), provided especially with contact clips, in a sealed manner into a housing (2) provided with a floor and covering lid (3), which gasket (1) comprises lead-through openings (4, 5, 6) adjacent to one another for the cables, with the diameter of said openings being smaller than the insulation diameter of the cables (7), the lead-through openings (4, 5, 6) of the gasket (1) are connected among each other by slits (8) and the cover lid (3) can be pressed against the inserted cables (7) within the terms of closing the slits (8) and by pressing the edges of the opening against the inserted cables (7) under elastic deformation of the gasket (1) and can be fastened in the pressing position in the housing (2).

### 1. FIELD OF THE INVENTION

The invention relates to a gasket made of an elastomer, especially silicone, for leading through several cables, provided especially with contact clips, in a sealed manner into a housing provided with floor and covering lid, which gasket comprises lead-through openings adjacent to one another for the cables, with the diameter of said openings being smaller than the insulation diameter of the cables.

### 2. DESCRIPTION OF THE PRIOR ART

In the case of known gaskets of this kind which are usually shaped in the form of mats it is necessary to choose the diameter of the lead-through openings for the cable substantially smaller than the insulation diameter of the cable, e.g. by 40%, in order to achieve sufficient sealing. This requires a considerable expenditure of force in sliding in the cables. For practical reasons it is necessary in the mass production to provide the cables with contact clips prior to sliding them in, which clips are preferably fastened by crimping to the cables and conductors. In production, they often have sharp, slightly protruding parts, so that it will be necessary in practice in order to avoid damage or uselessness of the gaskets to provide aftertreatment by regrinding sharp edges for example, thus causing an additional machining step and increased total costs. The insertion of the cables will also be delayed by the higher amount of effort and is cumbersome because any kinking or bending of the cables in the insertion region must be avoided.

### SUMMARY OF THE INVENTION

It is the object of the present invention to eliminate the indicated disadvantages and to create a gasket, into which cables provided with contact clips not after-treated can be inserted with little force and thus a low likelihood of kinking or bending and in which perfect sealing is nevertheless ensured.

This object is achieved in such a way that the lead-through openings of the gasket are connected among each other by slits and the cover lid can be pressed against these cables within the terms of closing the slits and by pressing the edges of the opening against the inserted cables under elastic deformation of the gasket and can be fastened in the pressing position in the housing.

The slits provide the gasket mat with a higher resilience and the gasket mat can also widen towards the slits during the insertion of the cables into the openings.

According to a further development, the gasket even consists of two halves fully divided according to the slits.

The necessary pressing of the opening walls and the compression of the slit(s) is thus enabled in a simple way that the gasket body comprises outside regions which are inclined or bulged in the relaxed installation state, are inclined towards the lead-through openings and are set flat or flatter while resting in the clamping position supported on the housing wall and thus close the slit(s) and constrict the lead-through opening.

According to one other possibility, the covering lid and/or the floor of the housing is provided with guide surfaces which face the gasket and are wedge-shaped for the purpose of displacing the gasket material pressurized by the same in the direction of the slits and the lead-through openings.

From a constructional standpoint there is the possibility to fasten the covering lid in the pressing position on the gasket by means of a snap-on mounting or a weld or adhesive seam to the housing.

According to a variant the housing can also consist of two diametrically opposed halves which can be latched together against the cables in the pressing position of the gasket.

Further details and advantages of the subject matter of the invention are shown in the following description of the drawings.

### BRIEF DESCRIPTION OF THE DRAWINGS

The subject matter of the invention is shown by way of example in the drawings, wherein:

FIG. 1 shows a top view of a gasket in accordance with the invention with the covering lid removed;

FIG. 2 shows the state of the gasket during the insertion of the cables in a sectional view along line II-II according to FIG. 1;

FIG. 3 shows the state after the pressing of the covering lid in the illustration according to FIG. 2, and

FIGS. 4 and 5 show two further variants of the gasket in the illustration according to FIG. 2.

### DESCRIPTION OF THE PREFERRED EMBODIMENT

A housing 2 is provided for the gasket configured for receiving a sealing mat 1, which housing can be sealed by a covering lid 3 which in accordance with FIG. 3 can be rigidly connected with the housing 2 in an inserted position. Welding such as ultrasonic welding or gluing can be used for the connection in the position according to FIG. 3. It is also possible to connect the covering lid 3 with the housing 2 by a snap-on mounting. Housing 2 and covering lid 3 are preferably made of a thermoplastic material.

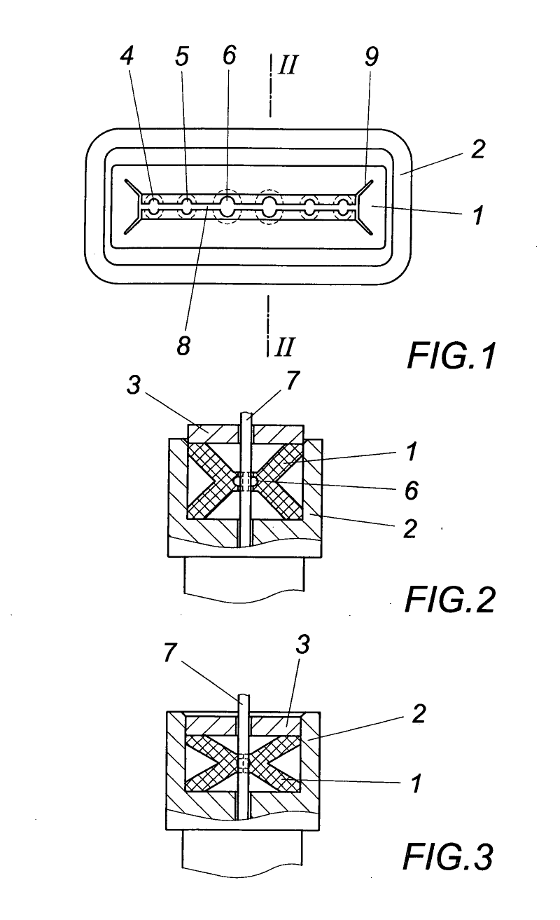

In accordance with the embodiments according to FIGS. 1 to 3, the sealing mat 1 has a substantially X-shaped cross section, with lead-through openings 4, 5, 6 for single-conductor cables (e.g. 7) being provided in the connection of the two X-legs, which lead-through openings 4, 5, 6 are connected by slits 8. In order to increase elasticity, the sealing mat 1 comprises incisions 9 adjacent to the outer slit ends.

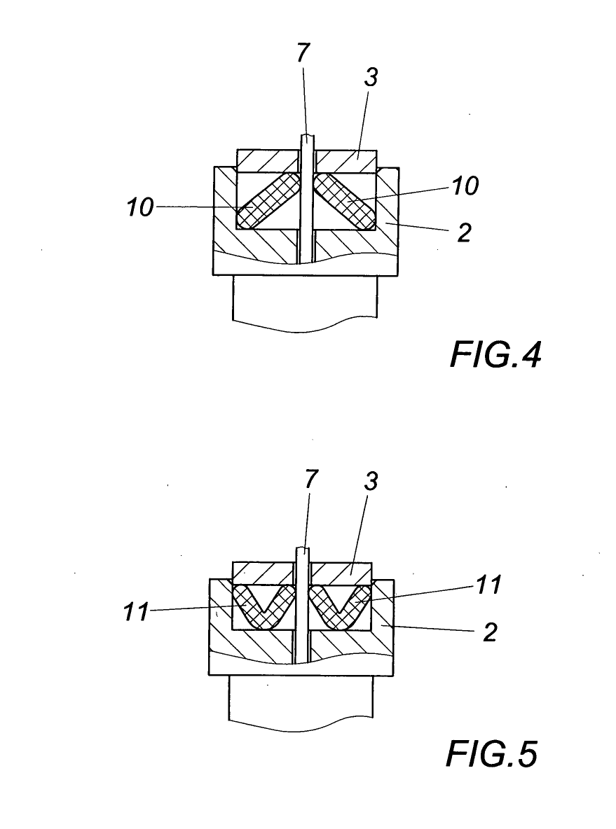

After the insertion of the cables 7 according to FIG. 2, the covering lid 3 is pressed into the housing 2 and is fastened, as described. The inclined position of the X-legs thus changes, so that they compress the slits 8, 9 and also press the walls of the lead-through openings 4, 5, 6 against the sheath of the cable, so that perfect sealing is achieved. In the embodiment according to FIG. 4, two gasket halves 10 divided by the slit are placed as shown in an inclined manner in the housing 2, so that they assume their sealing position again when the covering lid 3 is pressed tight.

The same applies to the embodiment according to FIG. 5, according to which two gasket halves with a V-shaped cross section are inserted as shown, so that they are placed in a sealing manner on cables 7 when the covering lid 3 is pressed in and the mentioned separating slit is closed simultaneously.

1. A gasket made of an elastomer, especially silicone, for leading through several single-conductor cables, provided especially with contact clips, in a sealed manner into a housing provided with floor and covering lid, which gasket comprises lead-through openings adjacent to one another for the cables, with the diameter of said openings being smaller than the insulation diameter of the cables, wherein the lead-through openings (4, 5, 6) of the gasket (1, 10, 11) are connected among each other by slits (8) and the cover lid (3) can be pressed against the inserted cables (7) within the terms of closing the slits (8) and by pressing the edges of the opening against the inserted cables (7) under elastic deformation of the gasket and can be fastened in the pressing position in the housing (2).

2. A gasket according to claim 1, wherein the gasket consists of two halves (10, 11) fully divided according to the slits.

3. A gasket according to claim 1, wherein the gasket body (1, 10, 11) comprises outside regions which are inclined or bulged in the relaxed installation state, are inclined towards the lead-through openings and are set flat or flatter while resting in the clamping position supported on the housing wall (2) and thus close the slit(s) (8) and constrict the lead-through opening (4, 5, 6).

4. A gasket according to claim 1, wherein the covering lid (3) and/or the floor of the housing (2) is provided with guide surfaces which face the gasket (1, 10, 11) and are wedge-shaped for the purpose of displacing the gasket material pressurized by the same in the direction of the slits (8) and the lead-through openings (4, 5, 6).

5. A gasket according to claim 1, wherein the covering lid (3) is fastened in the pressing position on the gasket (1, 10, 11) by means of a snap-on mounting or a weld or adhesive seam to the housing (2).

6. A gasket according to claim 1, wherein the housing consists of two diametrically opposed halves which can be latched together against the cables in the pressing position.
